(19) United States
(12) Patent Application Publication
(10) Pub. No.: US 2007/0156497 A1
(43) Pub. Date: Jul. 5, 2007

(54) Interactive communications service and system

(76) Inventor: Anthony Ramsey, Overland Park, KS (US)

Correspondence Address: CHASE LAW FIRM L.C, 4400 COLLEGE BOULEVARD, SUITE 130, OVERLAND PARK, KS, 66211, US

(21) Appl. No.: 11/602,772

(22) Filed: Nov. 21, 2006

Related U.S. Application Data
(60) Provisional application No. 60/751,939, filed on Dec. 21, 2005.

(51) Int. Cl. G05B 19/418; G06F 9/46

(52) U.S. Cl. 705/8

(57) ABSTRACT

A method for establishing communication between at least two persons includes an initial introductory card handed by a first person/donor who wishes to establish a relationship with a second/person recipient. The recipient utilizes the identifying indicia on the card to ascertain more about the person on an internet-based website, the website containing a profile of the donor. If interested, the participant is presented further options to initiate further contact with the card donor through the website. The system enables a recipient to ascertain compatibility with a donor after an initial contact in which the donor presents the recipient with the card.

### CROSS REFERENCE TO RELATED APPLICATION

This application claims priority from provisional application Ser. No. 60/751,939, filed on Dec. 21, 2005, entitled “‘Isawyouat’ also known as ‘isawyouat.com.’”

### BACKGROUND OF THE INVENTION

This invention relates to a method and/or system for establishing a relationship between at least two persons and, more particularly, to an internet-based system for establishing the communication between two persons after an initial personal contact in which one person/donor presents an introductory card to the second person/recipient, which allows the latter access to an internet website. The recipient may then view a profile of the donor and establish e-mail contact with the donor, if desired.

In today's internet world, various websites have arisen which attempt to establish personal relationships between two persons. Although assumably effective in their operation, such websites are not based on the opportunity of a first person to have actually seen or established a face-to-face contact with the second person prior to internet contact. Such past systems do not enhance subsequent communications as no visual contact has been made. Such an initial visual contact diminishes some of the problems arising from past internet compatibility websites, such as the posting of false photos, false descriptions and other false information. Also, the problems arising from initial introduction, e.g., shyness, awkwardness and time constraints, can be eliminated.

### SUMMARY OF THE INVENTION

Basically my invention utilizes an internet website and a card which bears a code and password thereon. Upon viewing another person, the donor or his/her agent presents the card to the recipient, if further communications are desired. An interested recipient enters the website utilizing the code which identifies the donor. Upon entry a profile of the donor is presented. If further communication is desired, the recipient, as distinguished by the password, contacts the donor using the website as an intermediary for e-mail messages to pass therebetween. If desired, direct e-mail and/or face-to-face contact may be established between the donor and the recipient. The use of the introductory card allows the initial contact to be established by means of a visual contact in which at least one of the persons has seen the other. The use of the website as an intermediary for e-mail communications provides security for the recipient.

It is therefore a general object of the invention to provide a method for one person to meet a second person utilizing in part a card and internet website wherein the method is initiated by at least the one person viewing the second.

Another object of this invention is to provide a method, as aforesaid, which is initiated by the first person presenting an introductory greeting card to the second person/recipient.

A further object of this invention is to provide a method, as aforesaid, which allows the second person to peruse a profile of the first person on the internet website.

Still another object of this invention is to provide a method, as aforesaid, wherein the introductory card has means thereon to identify to the donor the circumstances surrounding the receipt of the card by the recipient.

Another object of this invention is to provide a method, as aforesaid, wherein the card allows the recipient to present his/her profile to the donor.

Still another object of this invention is to provide a method, as aforesaid, wherein the recipient can initiate further anonymous contact with the donor through the internet website.

Another object of this invention is to provide a method, as aforesaid, wherein the method can be utilized for various reasons beyond donor/recipient compatibility matching.

Other objects and advantages of this invention will become apparent from the following description taken in connection with the accompanying drawings, wherein is set forth by way of illustration and example, a now preferred embodiment of this invention.

### BRIEF DESCRIPTION OF THE DRAWINGS

FIG. 1 is an illustration showing the front of the introductory card including the top and bottom portions thereof;

FIG. 2 is a rear view of the introductory card of FIG. 1;

FIG. 3 is a view showing one form of a profile which is to be filled in by the donor and/or the recipient on the website;

FIG. 4 is a view showing the e-mail page of the internet system; and

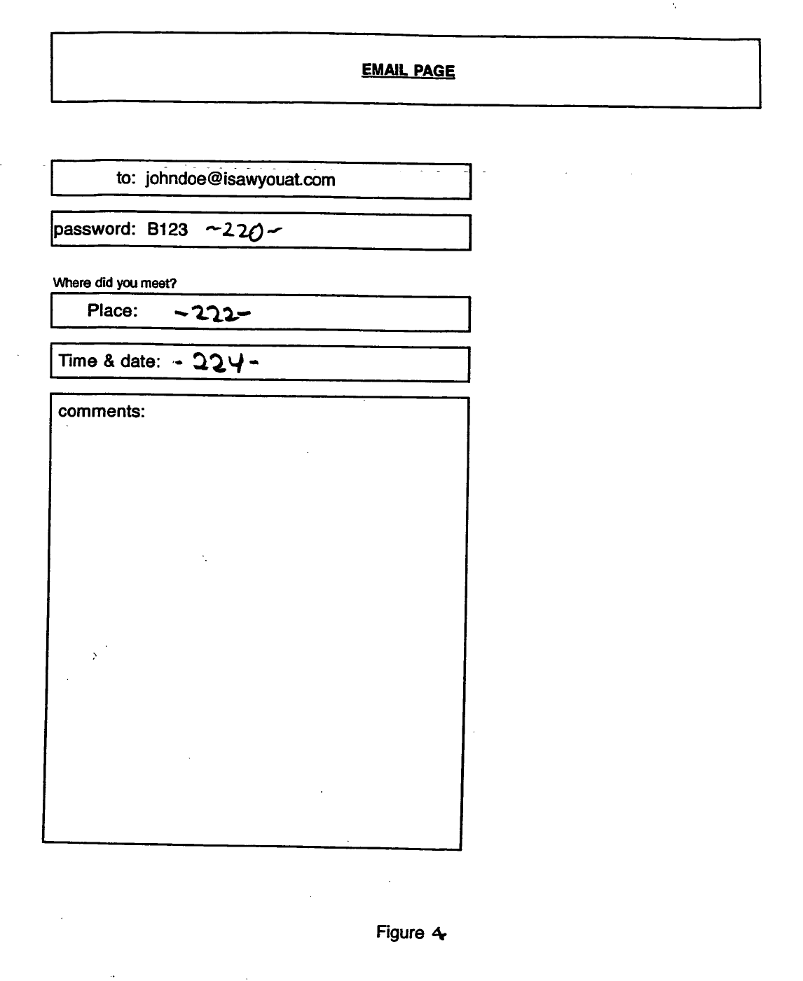

FIG. 5 shows the print page of the website in which a number of introductory cards are presented to the donor for further use.

### DESCRIPTION OF THE PREFERRED EMBODIMENT

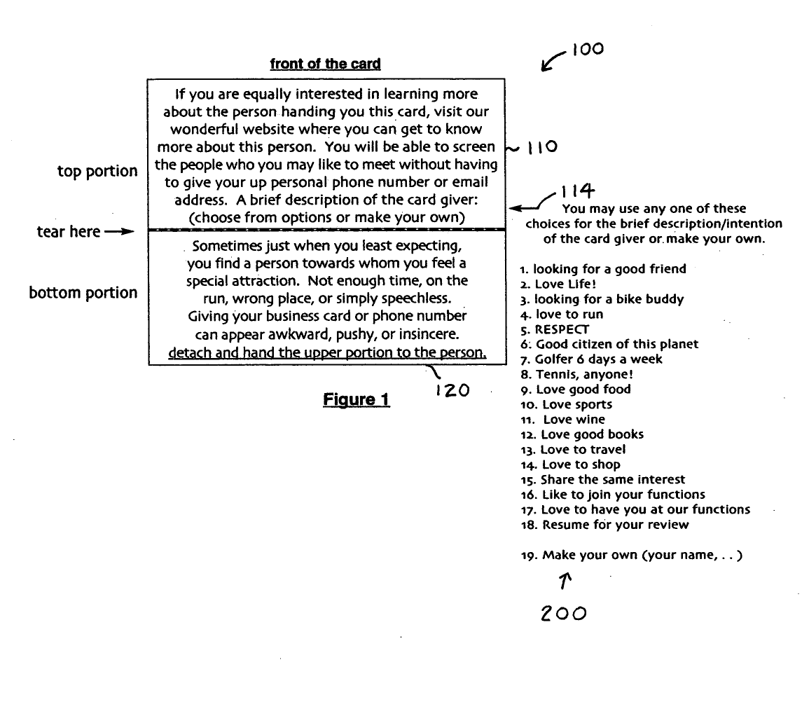

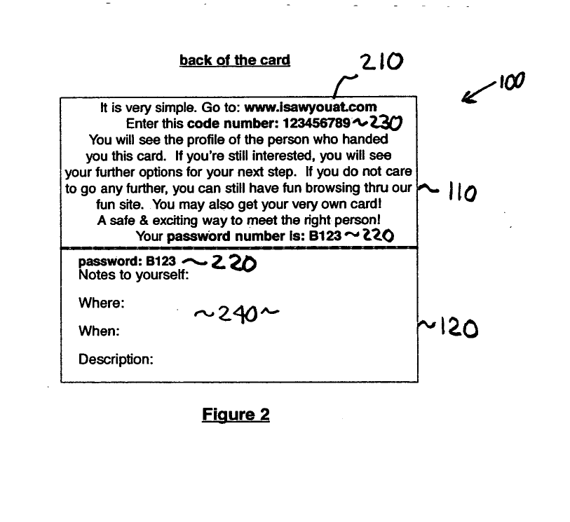

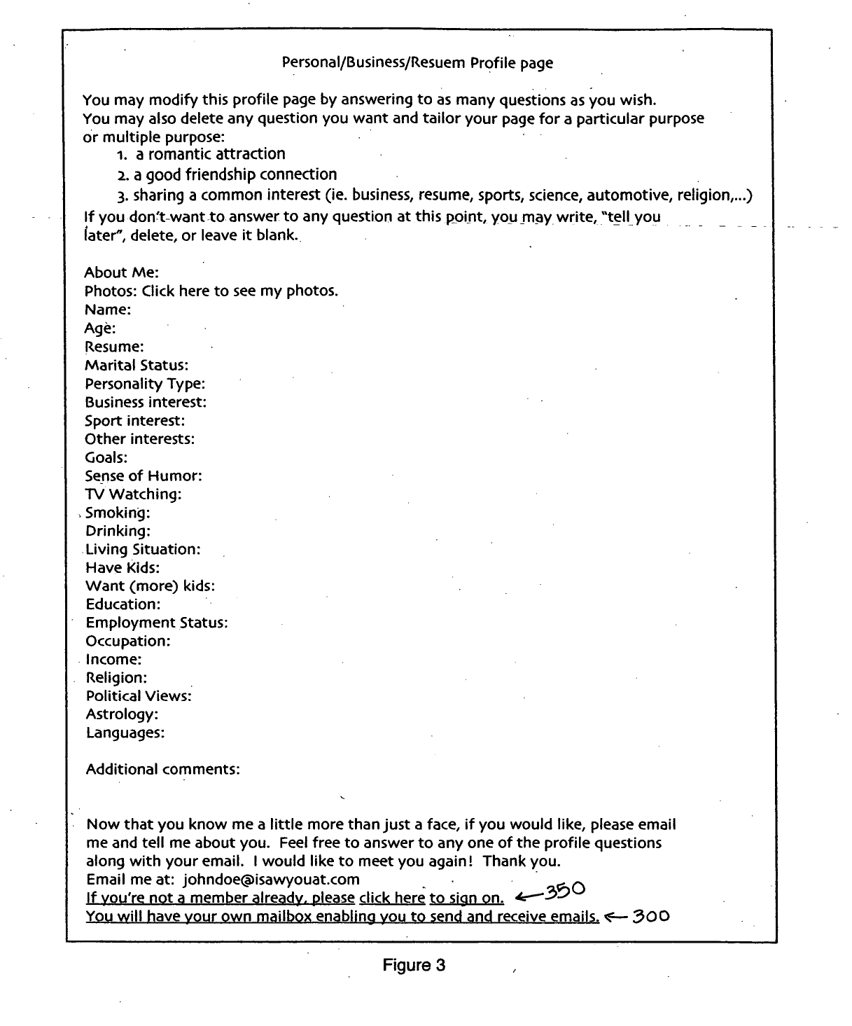

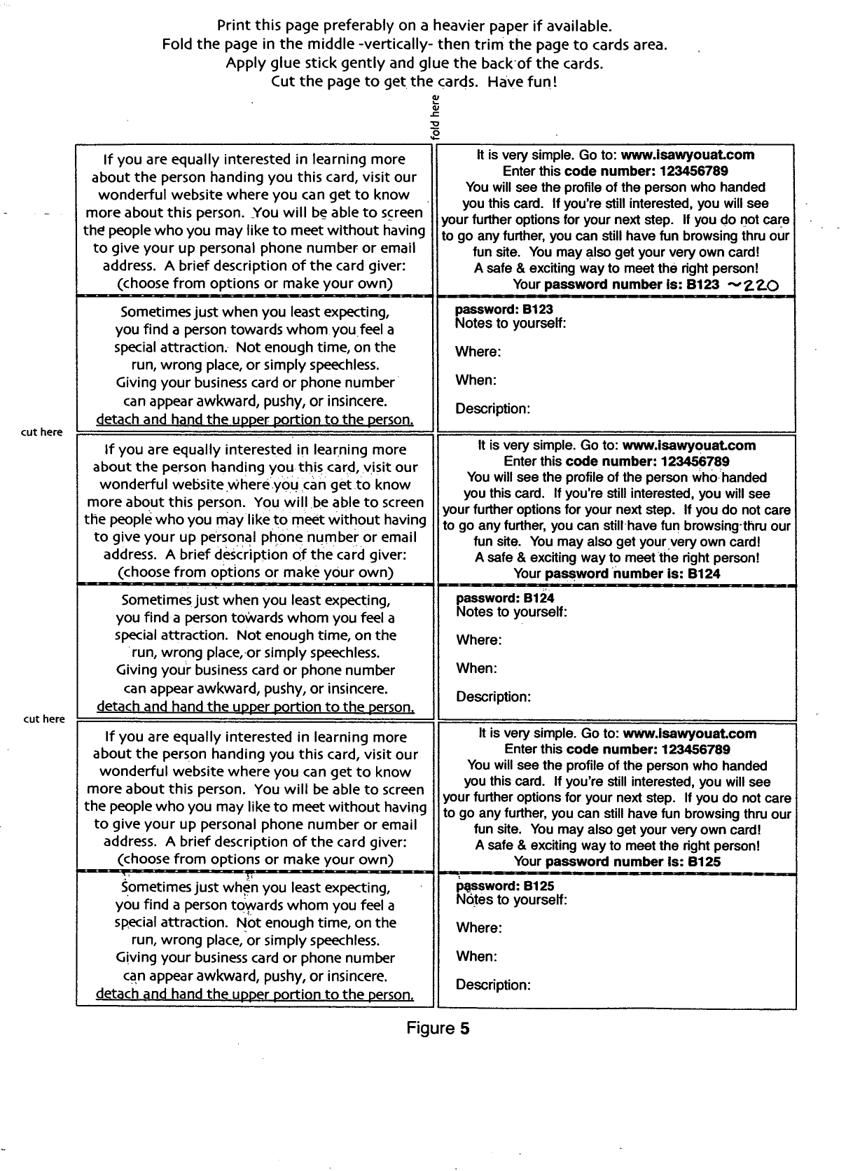

My method utilizes an internet website which has a profile (FIG. 3) as previously filled out by a registered member of the website. FIGS. 1 and 2 show an introductory card 100 having first 110 and second 120 portions with a score line 116 therebetween. The top portion 110 of the card 100 includes a brief description of the card and the intention of the card donor. As shown in FIG. 5, the website is designed to first present the cards 100 to the donor and allow the donor to insert his/her intentions in card portion 110 at 114 which may be selected from a table 200 of options located on the website.

On the back side of the card 100 (FIG. 2) is included a website identification 210, a password 220 and a code number 230.

In a setting wherein the first person/donor is interested in establishing a communication with a viewed second person/recipient it is not always possible to have an extended face-to-face meeting with the second person/recipient, if at all. As such the donor will hand the recipient the top portion 110 of the card 100 either personally or through an intermediary. The recipient may initiate an extended face-to-face contact with the donor if he/she desires. As shown in FIG. 2, each card contains the website identification 210, a code number 230 and a password 220. The password 220 on the top 110 and bottom portion 120 of the card 100 changes so that the donor may differentiate among the persons to whom cards were given. The donor may also enter notes in the provided spaces 240 of portion 120 so as to further coordinate the donated portions 110 of the cards with particular recipients.

Subsequently, having retained possession of the card top portion 110 the recipient may go to a computer, pull up the identified website 210 and enter the code 230 therein. Upon code 230 entry the recipient is presented with a profile of the donor as shown in FIG. 3 which has been previously filled out by the donor upon website registration. If the recipient is interested in further communication with the donor he/she may do so through e-mail 300 as routed through the website as shown in FIG. 3 upon becoming a member of the website 350. At this time the password 220 is entered by the recipient so as to identify to the donor the circumstances in which the card 100 was presented. Additional information, e.g., the place 222, time and date 224, may be entered at this time. Thus, the recipient at this time need not identify a personal e-mail address to the donor. Concurrently, the recipient has the option of filling out a profile in the format as shown in FIG. 3 in whole or in part upon becoming a member of the service at 350 (FIG. 3). Once a member, the recipient can establish the above e-mail contact with the donor through the website. Also, the donor will then have access to the FIG. 3 profile as filled out by the recipient. Upon further communications between the donor and the recipient, the recipient has the option of providing a direct e-mail address so that direct communication and future personal contact may follow.

Accordingly my method enables an interested donor to establish a communication with a desired recipient after an initial visual contact. This initial contact aids in establishing a desire for further communications between the donor and the recipient if the recipient so desires. Subsequent communications may be directed through the website until both the donor and recipient decide that more direct communication such as face-to-face contact is appropriate.

My method may be utilized in establishing a romantic, friendly or business relationship between at least two persons. As such, the FIG. 3 profile may change according to the intent of the donor so as to reflect the desired relationship. For example, the profile can be changed according to the selection made by the donor from table 200.

It is to be understood that while certain forms of this invention have been illustrated and described, it is not limited thereto, except in so far as such limitations are included in the following claims and allowable equivalents thereof.

Having thus described the invention, what is claimed as new and desired to be secured by Letters Patent is:

1. A method of establishing communications between at least two persons comprising:
providing a telecommunications network wherein at least a first person is identified therein by a code;
providing an introductory card having an identification of said network and said code thereon;
providing a first person profile on said network associated with said first person;
presenting said card to a second person by said first person;
accessing said network by said second person, said network identified on said card;
accessing a profile of said first person on said network by said second person according to said code on said card; and
providing means for said second person to contact said first person through said network at the option of said second person.

2. The method as claimed in claim 1 wherein said introductory card comprises a portion retained by said first person, said card having space thereon for recording information thereon.

3. The method as claimed in claim 1 wherein said introductory card includes a code for identifying said second person on said network.

4. The method as claimed in claim 1 wherein said step of providing means for contact further comprises the steps of:
presenting means to said second person for e-mail communication with said first person at an option of said second person.

5. The method as claimed in claim 3 wherein said steps of presenting means for contact further comprises:
presenting to said second person a form to be filled out by second person at said second person's option, said filled out form providing information identifying said second person to said first person and including said code identifying said second person;
providing said form to said first person.

6. The method as claimed in claim 1 wherein said step of providing an introductory card comprises the steps of:
presenting through said network at least one said introductory cards to said first person;
presenting through said network a table of reasons for said first person meeting said second person;
inserting one of said reasons from said table onto said at least one card;
printing said at least one card including said inserted reason thereon for use in said step of presenting said card to said second person.

7. The method as claimed in claim 1 wherein said presented introductory card includes indicia thereon to distinguish one card from the other whereby said first person can distinguish said second persons receiving said cards.

8. The method as claimed in claim 7 wherein said indicia includes a variable code.

9. A method of establishing communications between at least two persons involving a telecommunications network comprising:
providing a code wherein at least a first person is identified on the network by a code number;
providing a card having an identification of said network and said code thereon;
providing a first person profile on said network associated with said person;
presenting said card to a second person by said first person;
accessing said network by said second person, said network identified on said card;
accessing said profile of said first person on said network according to said code on said card; and
contacting said first person through said network at the option of said second person.

10. The method as claimed in claim 9 wherein said code comprises:
a first portion for said presenting to said second person;
a second portion separable from said first portion to be retained by said first person, said card second portion having indicia thereon for identifying the circumstances associated with presenting said card first portion to said second person.

11. The method as claimed in claim 10 wherein said indicia comprises a code identifying said second person.

12. The method as claimed in claim 11 wherein said second portion further comprises space for recording information thereon about said circumstances.

13. The method as claimed in claim 9 wherein said contacting step further comprises the steps of:
presenting on said network a blank form to be filled out by said second person, said form further identifying said second person; and
presenting said filled out form to said first person at an option of said second person.

14. A system for establishing communications between at least a first and second person comprising:
a telecommunications network accessible by said first and second persons, wherein at least characteristics of the first person are stored according to an address code;
an introductory card having an identification of said network and said address code number thereon, said card being given to a second person by said first person desirous of communication therewith;
means in said network for accessing said first person characteristics according to said address code on said card;
means in said network for said second person to contact said first person at the option of said second person.

15. The system as claimed in claim 14 wherein said card comprises:
a first portion for presenting to said second person;
a second portion for retainment by said first person, said second portion having means thereon for identifying the circumstances surrounding the presenting of said card to said second person.

16. The system as claimed in claim 15 wherein said identifying means comprises space thereon for recording said circumstances thereon.

17. The system as claimed in claim 16 wherein said identifying means comprises a code thereon for identifying said second person upon contact of said second person with said first person.

18. The system as claimed in claim 14 wherein said contact means comprises an e-mail communication between said first and second persons through said website.

19. The system as claimed in claim 18 wherein said contact means further comprises:
a form presented to said second person upon access of said network, said form adapted to be filled out by said second person to establish a profile of said second person, said form presented to said first person upon said e-mail communication.

20. The system as claimed in claim 19 further comprising means on said form for identifying to said first person the circumstances surrounding the presenting of said card to said second person.
